(19) United States
(12) Patent Application Publication
(10) Pub. No.: US 2016/0274724 A1
(43) Pub. Date: Sep. 22, 2016

(54) Pressure Sensing and Touch Sensitive Panel, Pressure Sensing Method, Pressure Sensing Electronic Device and Control Unit Thereof

(71) Applicant: EGALAX_EMPIA TECHNOLOGY INC., Taipei City (TW)

(72) Inventor: Chin-Fu CHANG, Taipei City (TW)

(21) Appl. No.: 15/073,871

(22) Filed: Mar. 18, 2016

Related U.S. Application Data
(60) Provisional application No. 62/135,903, filed on Mar. 20, 2015.

(30) Foreign Application Priority Data
Dec. 31, 2015 (TW) 104144641

(51) Int. Cl. G06F 3/041; G06F 3/044

(52) U.S. Cl. CPC G06F 3/0416; G06F 3/044; G06F 3/0414

(57) ABSTRACT

The present invention provides a pressure sensing and touch sensitive panel, which includes sequentially a first electrode layer, a first dielectric layer, a second electrode layer, a deformable dielectric layer, and a third electrode layer.

### CROSS REFERENCE TO RELATED APPLICATIONS

This application claims priority to U.S. provisional patent application, 62/135,903, filed on Mar. 20, 2015 and to Taiwan patent application, 104144641, filed on Dec. 31, 2015, the disclosures of which are incorporated herein by reference.

### BACKGROUND OF THE INVENTION

1. Field of the Invention

The present invention relates to the field of pressure sensing, and more particularly, to the structure of pressure sensing panel and the pressure sensing method thereof.

2. Description of the Prior Art

Existing touch panels detect an external object by the change of physical quantities, such as the change of capacitance, which occurs when the external object approach to or touch on the touch panels. But, most of them only can detect the approach or touch position. If the pressure on the surface of the touch panel can further be detected, the different signals thus can be derived based on the change of detected pressure value for providing to the electronic device as new function developments. Current capacitive touch panel can detect the capacitive increase produced by the area increase of the external object, but the accuracy is poor and it is easy to be misjudged.

Thus, a pressure sensing panel and an electronic device applied the pressure sensing panel are required. They can detect pressure correctly and can also calculate the centeroid position and the strength of the pressure exerted by the external object.

From the above it is clear that prior art still has shortcomings. In order to solve these problems, efforts have long been made in vain, while ordinary products and methods offering no appropriate structures and methods. Thus, there is a need in the industry for a novel technique that solves these problems.

### SUMMARY OF THE INVENTION

One aspect of the present invention is to provide a pressure sensing electronic device, including: a pressure sensing and touch sensitive panel; and a control unit. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The multiple first and second electrodes all connect to the control unit.

One aspect of the present invention is to provide a pressure sensing and touch sensitive panel including sequentially a first electrode layer, a first dielectric layer, a second electrode layer, a deformable dielectric layer, and a third electrode layer.

One aspect of the present invention is to provide a pressure sensing method, which is adapted to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The pressure sensing method includes providing a driving signal to the multiple first electrodes in turn, detecting the multiple second electrodes to get multiple sensing signals at each time of the driving signal provided so as to form a one-dimension sensing information, forming a two-dimension sensing information by multiple one-dimension sensing information after all the multiple first electrodes having been provided the driving signal, and comparing the two-dimension sensing information to a base sensing image, which has no any applied pressure, to calculate a pressure on the pressure sensing and touch sensitive panel.

One aspect of the present invention is to provide a pressure sensing method, which is adapted to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The pressure sensing method includes providing a driving signal to all the multiple first electrodes and getting a one-dimension whole screen sensing information from the multiple second electrodes, comparing the one-dimension whole screen sensing information to a base one-dimension whole screen sensing information, which has no any applied pressure, for producing a difference, and determining the pressure sensing and touch sensitive panel has no applied pressure when the difference is within a range.

One aspect of the present invention is to provide a control unit, which connects to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The control unit includes a driving circuit, a sensing circuit, and a processor. The processor is configured to make the driving circuit provide a driving signal to the multiple first electrodes in turn, to make the sensing circuit detect the multiple second electrodes to get multiple sensing signals at each time of the driving signal provided so as to form a one-dimension sensing information, to form a two-dimension sensing information by multiple one-dimension sensing information after all the first electrodes having been provided the driving signal, and to compare the two-dimension sensing information to a base sensing image, which has no any applied pressure, to calculate a pressure on the pressure sensing and touch sensitive panel.

One aspect of the present invention is to provide a control unit, which connects to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The control unit includes a driving circuit, a sensing circuit, and a processor. The processor is configured to make the driving circuit provide a driving signal to all the multiple first electrodes, to make the sensing circuit get a one-dimension whole screen sensing information from the multiple second electrodes, to compare the one-dimension whole screen sensing information to a base one-dimension whole screen sensing information, which has no any applied pressure, for producing a difference, and to determine the pressure sensing and touch sensitive panel has no applied pressure when the difference is within a range.

To be brief, one of the objects of the present invention is to utilize three electrode layers provided by a pressure sensing panel to form at least two capacitors, and to change the capacitive coupling of one of these two capacitors after a force taken. By detecting sensed electrical change of the middle electrode layer before and after force taken, the capacitive change related to a pressure can be derived and the pressure position, centeroid, and level on the pressure sensing panel can be calculated more precisely.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 depicts a diagram of a pressure sensing and touch sensitive device in accordance with an embodiment of the present invention;

FIG. 2 depicts a structure diagram of a pressure sensing and touch sensitive panel in accordance with an embodiment of the present invention;

FIG. 3 depicts a perspective structure diagram of a pressure sensing and touch sensitive panel in accordance with an embodiment of the present invention;

FIG. 4 illustrates a diagram of a pressure sensing and touch sensitive device in accordance with an embodiment of the present invention;

FIG. 5 illustrates a diagram of having pressure on the pressure sensing and touch sensitive device shown in FIG. 4;

FIG. 6 illustrates a diagram of a pressure sensing and touch sensitive device in accordance with an embodiment of the present invention; and

FIG. 7 shows a flow chart of a pressure sensing method in accordance with an embodiment of the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

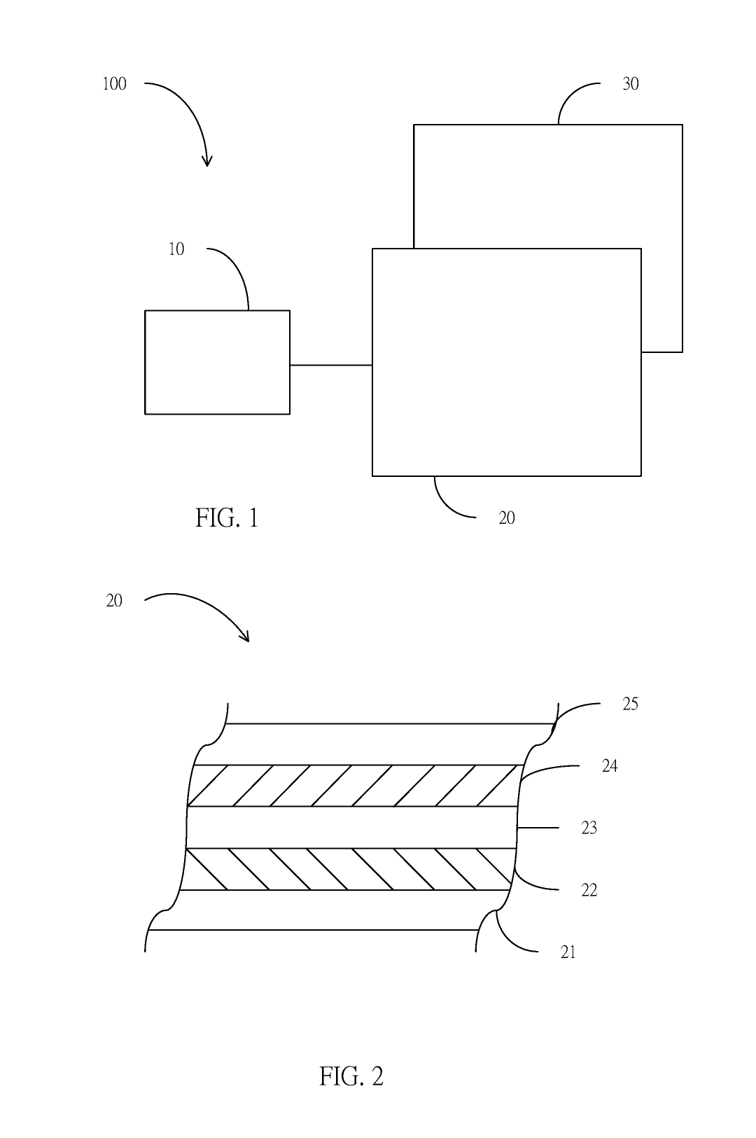

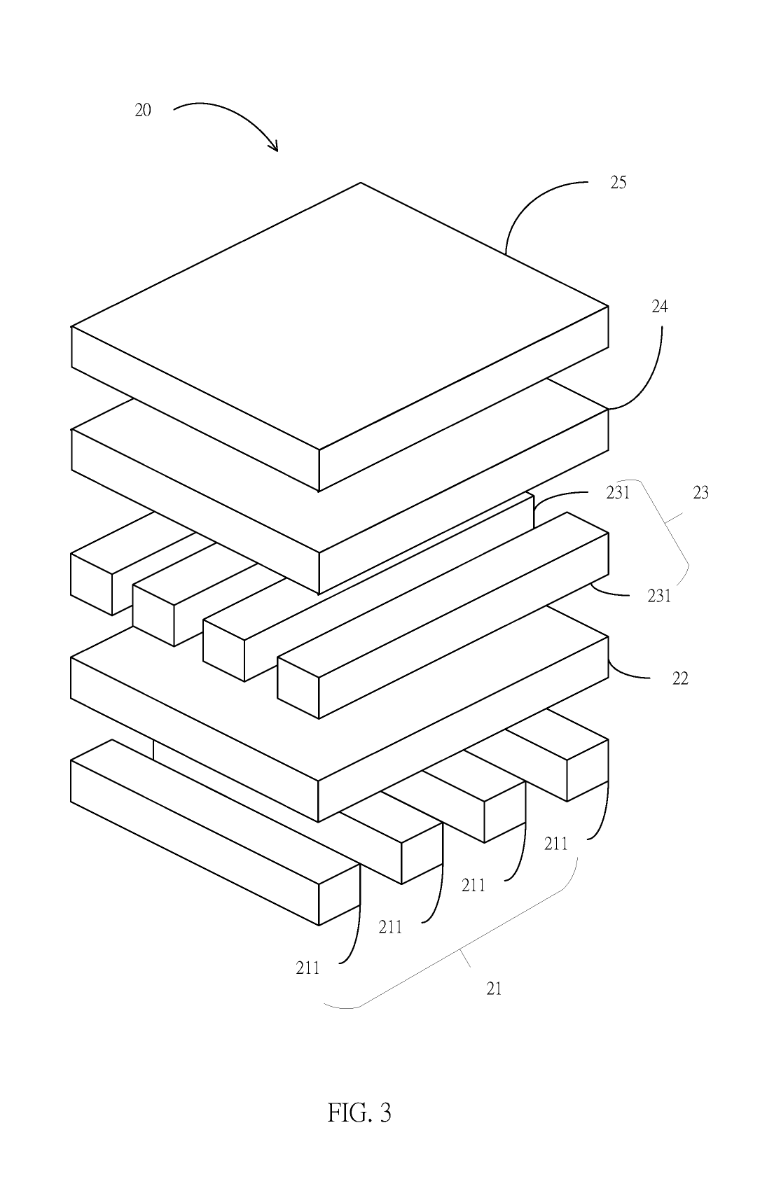

Referring to FIG. 1, a diagram of a pressure sensing and sensitive device 100 in accordance with an embodiment of the present invention is illustrated. Referring to FIG. 2, a structure diagram of a pressure sensing and touch sensitive panel in accordance with an embodiment of the present invention is illustrated. Referring to FIG. 3, a perspective structure diagram of a pressure sensing and touch sensitive panel in accordance with an embodiment of the present invention is illustrated. A first embodiment of the present invention may be shown in FIGS. 1 to 3.

As shown in FIG. 1, the pressure sensing and touch sensitive device 100 mainly includes a control unit 10 and a pressure sensing and touch sensitive panel 20, and may further include a displaying screen 30. The pressure sensing and touch sensitive panel 20 is in front of the displaying screen 30.

As the embodiment shown in FIG. 2, the pressure sensing and touch sensitive panel 20 primarily includes a first electrode layer 21, a first dielectric layer 22, a second electrode layer 23, a deformable dielectric layer 24, and a third electrode layer 25.

As matching up those shown in FIG. 3, the first electrode layer 21 includes multiple driving electrodes 211 (or first electrodes 211) being in parallel. Each driving electrode 211 is electrically coupled to the control unit 10 and is configured to receive a driving signal of the control unit 10. In the present embodiment, each driving electrode 211 is, for example, a transparent conductive strip, but not limit to. The transparent conductive strip may include the electrode structure in diamond shape, rectangle shape, and so forth. The first electrode layer 21 may be a transparent conductive film made by photolithography process.

The first dielectric layer 22 is between the first electrode layer 21 and the second electrode layer 23, and is configured to electrically isolate both of them. The first dielectric layer 22 may be made by all kinds of transparent inorganic or organic isolation materials.

The second electrode layer 23 includes multiple sensing electrodes 231 (or second electrodes 231) being in parallel. The sensing electrodes 231 intersect the driving electrodes 231 and are electrically coupled to the control unit 10. The sensing electrodes 231 are configured to generate corresponding capacitive coupling for the control unit 10 to measure when the driving electrodes 211 receive the driving signal. The second electrode layer 23 may be a transparent conductive film made by photolithography process.

It is noted, in the present embodiment, the first electrodes on the first electrode layer 21 are used to be the driving electrodes, and the second electrodes on the second electrode layer 23 are used to be the sensing electrodes, but not limit to. However, the first electrodes on the first electrode layer 21 may be used to be the sensing electrodes, and the second electrodes on the second electrode layer 23 may be used to be the driving electrodes 231.

The deformable dielectric layer 24 is on the second electrode layer 23 and is made by deformable materials, for example, silicone-like material, transparent elasticity material, or compressible material. The deformable dielectric layer 24 may be formed on the second electrode layer 23 by coating or printing, or may be formed in monomer first and then being attached to the second electrode layer 23.

The third electrode layer 25 is on the deformable dielectric layer 24, and may include a transparent substrate made by, for example, glass or plastic isolation material. The transparent substrate has suitable elasticity, which can be bended downward to a predefined extent when an external object presses on it. A transparent conductive film is formed on the bottom surface of the transparent substrate and substantially covers the transparent substrate.

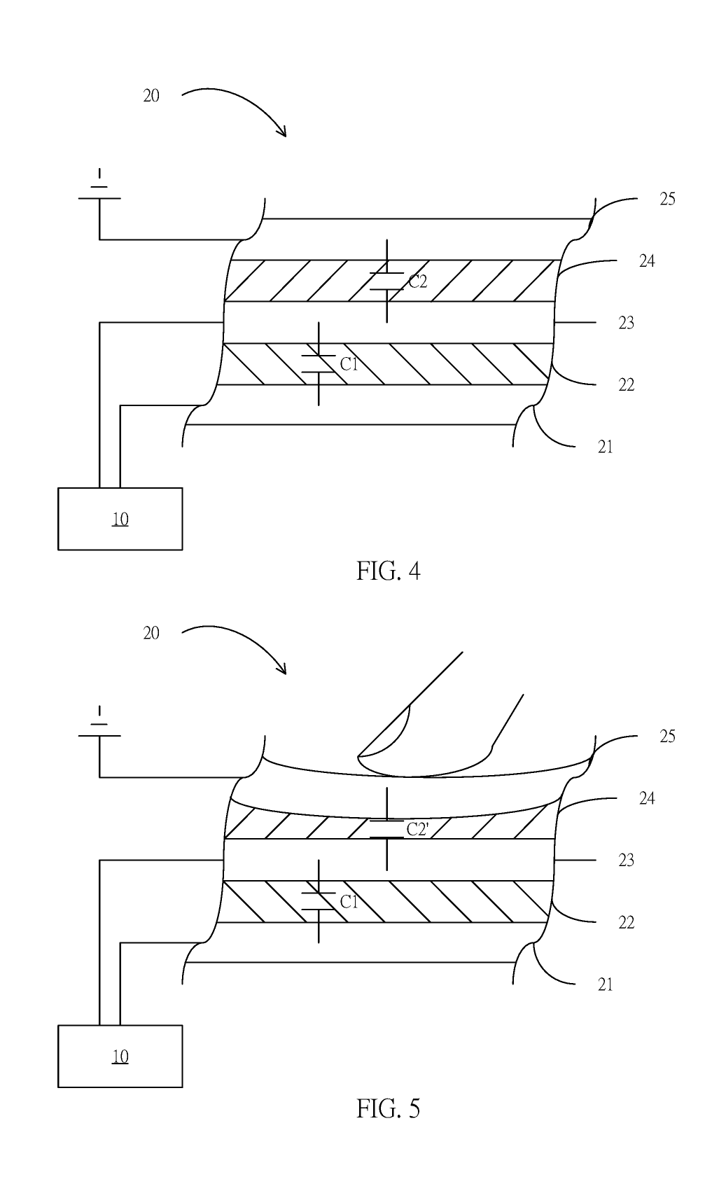

Referring to FIG. 4, a diagram of a pressure sensing and touch sensitive device in accordance with an embodiment of the present invention is shown. Referring to FIG. 5, a diagram of having pressure on the pressure sensing and touch sensitive device shown in FIG. 4 is shown.

In real operation, the driving signal is provided to the first electrode layer 21 by the control unit 10, and then the capacitive coupling C1 on each position between the first electrode layer 21 and the second electrode layer 23 is detected or sensed by the second electrode layer 23. Moreover, the third electrode layer 25 is grounded and there is another capacitive coupling C2 existing between the second electrode layer 23 and the third electrode layer 25. When an external object, such as a finger or stylus, touches or presses the pressure sensing and touch sensitive panel 20, for example, as shown in FIG. 5, the third electrode layer 25 on the top and the deformable dielectric layer 24 are deformed downward such that the capacitive coupling between the second electrode layer 23 and the third electrode layer 25 is changed to C2′ and thus affecting the signal strength detected or sensed by the control unit 10 through the second electrode layer 23. Through driving the first electrode layer 21 by the control unit 10, and detecting or sensing all changes on capacitive coupling by all sensing electrodes 231 on the second electrode layer 23, the position touched by the external object can be derived. Furthermore, according to the signal strength detected or sensed by the control unit 10 through the second electrode layer 23, the pressure level the external object touches (or presses) the pressure sensing and touch sensitive panel 20 can also be derived by the control unit 10.

In certain embodiments, since the third electrode layer 25 covers the entire of the displaying screen 30, and when a user holds the electronic device, which includes the displaying screen 30, the third electrode layer 25 is touched by hand or other parts of body of the user. Accordingly, the third electrode layer 25 is grounded by human body and is unnecessarily connected to the grounded potential provided by the electronic device.

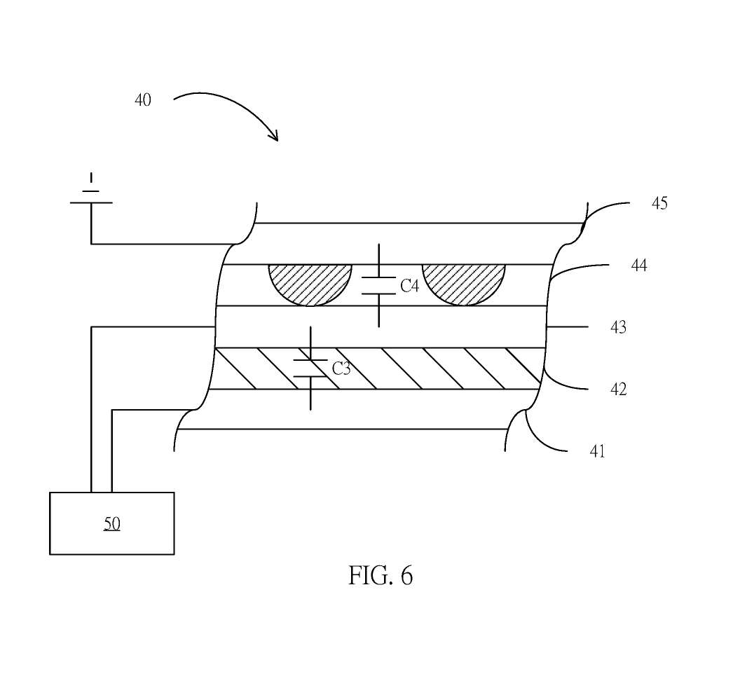

Referring to FIG. 6, a diagram of a pressure sensing and touch sensitive device in accordance with an embodiment of the present invention is depicted. In the present embodiment, the pressure sensing and touch sensitive panel 40 shown in FIG. 6 is approximately similar to the pressure sensing and touch sensitive panel 20 described in the first embodiment mentioned above. As shown in FIG. 6, the difference between both of them is that the deformable dielectric layer in the first embodiment is changed to a dot-spacer layer 44 in a second embodiment. The dot-spacer layer 44 is between the second electrode layer 43 and the third electrode layer 45. It can be formed on either the top surface of the second electrode layer 43 or the bottom surface of the third electrode layer 45. The dot-spacer layer 44 has multiple bumps on corresponding positions with interval arrangements. They may be made of hard or elastic materials.

In real operation, the driving signal is provided to the first electrode layer 41 by the control unit 50, and then the capacitive coupling C3 on each position between the first electrode layer 41 and the second electrode layer 43 is detected or sensed by the second electrode layer 43. Moreover, the third electrode layer 45 is grounded and there is another capacitive coupling C4 existing between the second electrode layer 43 and the third electrode layer 45. When an external object, such as a finger or stylus, touches or presses the pressure sensing and touch sensitive panel 40, the third electrode layer 45 on the top is deformed downward such that the capacitive coupling between the second electrode layer 43 and the third electrode layer 45 is changed and thus affecting the signal strength detected or sensed by the control unit 50 through the second electrode layer 43. Through driving the first electrode layer 41 by the control unit 50, and detecting or sensing all changes on capacitive coupling by all sensing electrodes on the second electrode layer 43, the position touched by the external object can be derived. Furthermore, according to the signal strength detected or sensed by the control unit 50 through the second electrode layer 43, the pressure level the external object touches (or presses) the pressure sensing and touch sensitive panel 40 can also be derived by the control unit 50.

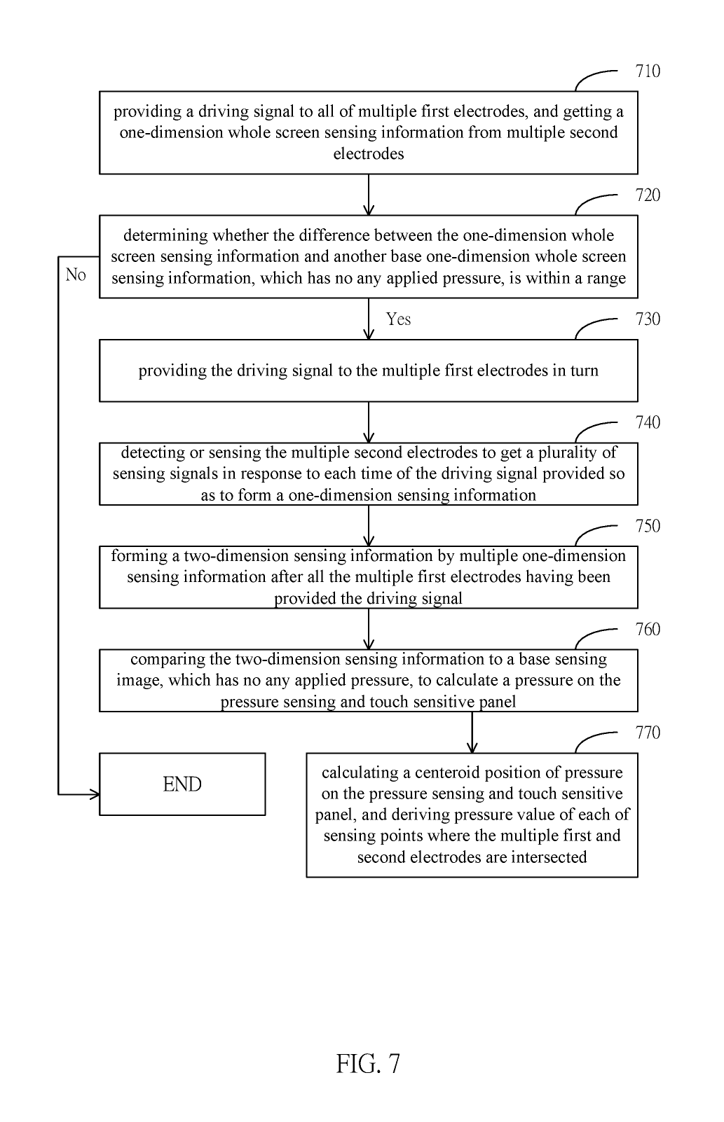

Referring to FIG. 7, a flow chart of a pressure sensing method in accordance with an embodiment of the present invention is shown. This method may be adapted to the control unit 10 or the control unit 50. Both of them implement this pressure sensing method by using, for example, a processor to run programs, that is, a software manner. Or, this pressure sensing method may be implemented in a hardware manner, or a combination manner of hardware and software. In one embodiment, the control unit includes at least one driving circuit, at least one sensing circuit, and a processor. The processor can perform the following steps, and the pressure sensing method includes the following steps.

In step 710: providing a driving signal to all of multiple first electrodes, and getting a one-dimension whole screen sensing information from multiple second electrodes.

In step 720: determining whether the difference between the one-dimension whole screen sensing information and another base one-dimension whole screen sensing information, which has no any applied pressure, is within a range. In certain an exemplary embodiment, the method for determining whether being over the range is, for example, to calculate the difference between the sum of the one-dimension whole screen sensing information and the sum of the base one-dimension whole screen sensing information, and if the difference exceeds a predefined value, it is determined being over the range. In another exemplary embodiment, the method for determining whether being over the range is, for example, to calculate the maximum difference between the one-dimension whole screen sensing information and the corresponding base one-dimension whole screen sensing information, and if the difference exceeds a predefined value, it is determined being over the range. In some exemplary embodiments, two determining methods mentioned above may be adapted at the same time, and if any determining method is true, it is determined being over the range. When being over the range is determined, step 730 is then performed; otherwise the flow ends.

In step 730: providing the driving signal to the multiple first electrodes in turn.

In step 740: detecting or sensing the multiple second electrodes to get a plurality of sensing signals in response to each time of the driving signal provided so as to form a one-dimension sensing information.

In step 750: forming a two-dimension sensing information by multiple one-dimension sensing information after all the multiple first electrodes having been provided the driving signal.

In step 760: comparing the two-dimension sensing information to a base sensing image, which has no any applied pressure, to calculate a pressure on the pressure sensing and touch sensitive panel.

In step 770: calculating a centeroid position of pressure on the pressure sensing and touch sensitive panel, and deriving pressure value of each of sensing points where the multiple first and second electrodes are intersected.

In one embodiment, the present invention provides a pressure sensing electronic device, including: a pressure sensing and touch sensitive panel; and a control unit. The pressure sensing and touch sensitive panel sequentially includes a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The multiple first and second electrodes all connect to the control unit.

The pressure sensing electronic device includes a displaying screen under the pressure sensing and touch sensitive panel. The first electrode layer, the first dielectric layer, the second electrode layer, the deformable dielectric layer, and the third electrode layer are transparent.

In one embodiment, the control unit provides the driving signal to the multiple first electrodes in turn. The multiple second electrodes are detected or sensed to get multiple sensing signals at each time of the driving signal provided so as to form a one-dimension sensing information. A two-dimension sensing information (or called a sensing image) is formed by multiple one-dimension sensing information after all the multiple first electrodes have been provided the driving signal. The control unit compares the two-dimension sensing information (or the sensing image) to a base sensing image, which has no any applied pressure. The difference value of each sensing point between the two sensing images corresponds to the change quantities C2 in FIG. 4 and C2′ in FIG. 5. According to the difference value of each sensing point, the control unit can calculate a centeroid position of the pressure on the pressure sensing and touch sensitive panel, and can get the pressure value of each sensing point by calculating or looking a lookup table.

In another embodiment, the control unit may provide the driving signal to all the multiple first electrodes firstly and get a one-dimension sensing information from the multiple second electrodes. When the one-dimension sensing information compares to a base one-dimension sensing information, which has no any applied pressure, and if the difference between both of them is within a range, it is determined the pressure sensing and touch sensitive panel has no applied pressure. If the difference exceeds the range, those steps mentioned above can be performed to calculate a centeroid position of the pressure on the pressure sensing and touch sensitive panel and the pressure value of each sensing point.

In one embodiment, the present invention provides a pressure sensing and touch sensitive panel, which includes sequentially a first electrode layer, a first dielectric layer, a second electrode layer, a deformable dielectric layer, and a third electrode layer.

The first electrode layer includes multiple first electrodes being parallel to a first direction, the second electrode layer includes multiple second electrodes being parallel to a second direction, the plurality of first and second electrodes all connect to a control unit. The first direction is perpendicular to the second direction.

The first electrode layer, the first dielectric layer, the second electrode layer, the deformable dielectric layer, and the third electrode layer are transparent.

The third electrode layer includes a transparent substrate and a transparent conductive film. The transparent conductive film is on the third electrode layer facing the deformable dielectric layer.

The deformable dielectric layer includes multiple insulating objects in interval arrangement to space the second electrode layer and the third electrode layer.

In some embodiments, the present disclosure provides a pressure sensing method, which is adapted to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The pressure sensing method includes providing a driving signal to the multiple first electrodes in turn, detecting the multiple second electrodes to get multiple sensing signals at each time of the driving signal provided so as to form a one-dimension sensing information, forming a two-dimension sensing information by multiple one-dimension sensing information after all the multiple first electrodes having been provided the driving signal, and comparing the two-dimension sensing information to a base sensing image, which has no any applied pressure, to calculate a pressure on the pressure sensing and touch sensitive panel.

The pressure sensing method further include calculating a centeroid position of the pressure on the pressure sensing and touch sensitive panel, and deriving a pressure value of each of sensing points where the multiple first and second electrodes are intersected.

In some embodiments, the present disclosure provides a pressure sensing method, which is adapted to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The pressure sensing method includes providing a driving signal to all the multiple first electrodes and getting a one-dimension whole screen sensing information from the multiple second electrodes, comparing the one-dimension whole screen sensing information to a base one-dimension whole screen sensing information, which has no any applied pressure, for producing a difference, and determining the pressure sensing and touch sensitive panel has no applied pressure when the difference is within a range.

In some embodiments, the present disclosure provides a control unit, which connects to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The control unit includes a driving circuit, a sensing circuit, and a processor. The processor is configured to make the driving circuit provide a driving signal to the multiple first electrodes in turn, to make the sensing circuit detect the multiple second electrodes to get multiple sensing signals at each time of the driving signal provided so as to form a one-dimension sensing information, to form a two-dimension sensing information by multiple one-dimension sensing information after all the first electrodes having been provided the driving signal, and to compare the two-dimension sensing information to a base sensing image, which has no any applied pressure, to calculate a pressure on the pressure sensing and touch sensitive panel.

In some embodiments, the present disclosure provides a control unit, which connects to a pressure sensing and touch sensitive panel. The pressure sensing and touch sensitive panel includes sequentially a first electrode layer, a first dielectric layer, a second electrode layer, a deformable dielectric layer, and a third electrode layer. The first electrode layer includes multiple first electrodes being parallel to a first direction. The second electrode layer includes multiple second electrodes being parallel to a second direction. The control unit includes a driving circuit, a sensing circuit, and a processor. The processor is configured to make the driving circuit provide a driving signal to all the multiple first electrodes and to make the sensing circuit get a one-dimension whole screen sensing information from the multiple second electrodes, to compare the one-dimension whole screen sensing information to a base one-dimension whole screen sensing information, which has no any applied pressure, for producing a difference, and to determine the pressure sensing and touch sensitive panel has no applied pressure when the difference is within a range.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A pressure sensing and touch sensitive panel, sequentially comprising:
a first electrode layer;
a first dielectric layer;
a second electrode layer;
a deformable dielectric layer; and
a third electrode layer.

2. The pressure sensing and touch sensitive panel of claim 1, wherein the first electrode layer includes a plurality of first electrodes being parallel to a first direction, the second electrode layer includes a plurality of second electrodes being parallel to a second direction, the plurality of first and second electrodes all connect to a control unit.

3. The pressure sensing and touch sensitive panel of claim 1, wherein the first electrode layer, the first dielectric layer, the second electrode layer, the deformable dielectric layer, and the third electrode layer are transparent.

4. The pressure sensing and touch sensitive panel of claim 1, wherein the third electrode layer includes a transparent substrate and a transparent conductive film, the transparent conductive film is on the third electrode layer facing the deformable dielectric layer.

5. The pressure sensing and touch sensitive panel of claim 1, wherein the deformable dielectric layer includes a plurality of insulating objects in interval arrangement to space the second electrode layer and the third electrode layer.

6. A pressure sensing electronic device, comprising:
a control unit; and
a pressure sensing and touch sensitive panel, further sequentially including a first electrode layer, a first dielectric layer, a second electrode layer, a deformable dielectric layer, and a third electrode layer, wherein the first electrode layer includes a plurality of first electrodes being parallel to a first direction, the second electrode layer includes a plurality of second electrodes being parallel to a second direction, the plurality of first and second electrodes all connect to the control unit.

7. A pressure sensing method adapted to a pressure sensing and touch sensitive panel, the pressure sensing and touch sensitive panel sequentially including a first electrode layer, a first dielectric layer, a second electrode layer, a deformable dielectric layer, and a third electrode layer, wherein the first electrode layer includes a plurality of first electrodes being parallel to a first direction, the second electrode layer includes a plurality of second electrodes being parallel to a second direction, wherein the pressure sensing method comprises:
providing a driving signal to the plurality of first electrodes in turn;
detecting the plurality of second electrodes to get a plurality of sensing signals at each time of the driving signal provided so as to form a one-dimension sensing information;
forming a two-dimension sensing information by a plurality of one-dimension sensing information after all the plurality of first electrodes having been provided the driving signal; and
comparing the two-dimension sensing information to a base sensing image, which has no any applied pressure, to calculate a pressure on the pressure sensing and touch sensitive panel.

8. The pressure sensing method of claim 7, further comprising:
calculating a centeroid position of the pressure on the pressure sensing and touch sensitive panel, and deriving pressure value of each of sensing points where the plurality of first and second electrodes are intersected.

9. A control unit connected to a pressure sensing and touch sensitive panel, the pressure sensing and touch sensitive panel sequentially including a first electrode layer, a first dielectric layer, a second electrode layer, a deformable dielectric layer, and a third electrode layer, wherein the first electrode layer includes a plurality of first electrodes being parallel to a first direction, the second electrode layer includes a plurality of second electrodes being parallel to a second direction, wherein the control unit comprises:
a driving circuit;
a sensing circuit; and
a processor, configured to make the driving circuit provide a driving signal to the plurality of first electrodes in turn, to make the sensing circuit detect the plurality of second electrodes to get a plurality of sensing signals at each time of the driving signal provided so as to form a one-dimension sensing information, to form a two-dimension sensing information by a plurality of one-dimension sensing information after all the plurality of first electrodes having been provided the driving signal, and to compare the two-dimension sensing information to a base sensing image, which has no any applied pressure, to calculate a pressure on the pressure sensing and touch sensitive panel.

10. The control unit of claim 9, wherein the processor is configured to calculate a centeroid position of the pressure on the pressure sensing and touch sensitive panel, and to derive pressure value of each of sensing points where the plurality of first and second electrodes are intersected.

11. A pressure sensing method adapted to a pressure sensing and touch sensitive panel, the pressure sensing and touch sensitive panel sequentially including a first electrode layer, a first dielectric layer, a second electrode layer, a deformable dielectric layer, and a third electrode layer, wherein the first electrode layer includes a plurality of first electrodes being parallel to a first direction, the second electrode layer includes a plurality of second electrodes being parallel to a second direction, wherein the pressure sensing method comprises:
providing a driving signal to all the plurality of first electrodes and getting a one-dimension whole screen sensing information from the plurality of second electrodes; and
comparing the one-dimension whole screen sensing information to a base one-dimension whole screen sensing information, which has no any applied pressure, for producing a difference and determining the pressure sensing and touch sensitive panel has no applied pressure when the difference is within a range.

12. A control unit connected to a pressure sensing and touch sensitive panel, the pressure sensing and touch sensitive panel sequentially including a first electrode layer, a first dielectric layer, a second electrode layer, a deformable dielectric layer, and a third electrode layer, wherein the first electrode layer includes a plurality of first electrodes being parallel to a first direction, the second electrode layer includes a plurality of second electrodes being parallel to a second direction, wherein the control unit comprises:
a driving circuit;
a sensing circuit; and
a processor, configured to make the driving circuit provide a driving signal to all the plurality of first electrodes and to make the sensing circuit get a one-dimension whole screen sensing information from the plurality of second electrodes, to compare the one-dimension whole screen sensing information to a base one-dimension whole screen sensing information, which has no any applied pressure, for producing a difference, and to determine the pressure sensing and touch sensitive panel has no applied pressure when the difference is within a range.
